(19) United States
(12) Patent Application Publication
(10) Pub. No.: US 2004/0050271 A1
(43) Pub. Date: Mar. 18, 2004

(54) Drive mechanism of a cylinder

(76) Inventor: Erich Max Karl Gerner, Butthard (DE)

Correspondence Address: Doughlas R. Hanscom, Jones Tullar & Cooper, Eads Station, P O Box 2266, Arlington, VA, 22202, US

(21) Appl. No.: 10/471,746

(22) PCT Filed: Feb. 5, 2002
(86) PCT No.: PCT/DE02/00414

(30) Foreign Application Priority Data
Mar. 26, 2001 (DE) 101 14 806.2

(51) Int. Cl. B41F 5/00

(52) U.S. Cl. 101/216

(57) ABSTRACT

Please add the Abstract Of The Disclosure as set forth on the separate accompanying sheet. That Abstract Of The Disclosure is essentially the same, in content, as the Abstract which is a part of the published PCT application WO 02/076742. No new matter is being added by the submission of this Abstract Of The Disclosure.

The invention relates to a drive mechanism for a cylinder in accordance with the preambles of claims 1, 2 or 8.

A printing group is known from DE 44 30 693 A1, wherein the forme cylinder is driven and its output is transmitted to the transfer cylinder via spur wheels. In one embodiment, a journal of the forme cylinder embodied as a rotor is axially displaceable in the stator for adjusting the lateral register on the forme cylinder. In one exemplary embodiment the forme and transfer cylinders are driven in pairs.

EP 0 722 831 B1 also discloses a drive for a cylinder, wherein the cylinder, which is driven by a motor, is axially displaceably arranged for the purpose of adjusting the lateral register. A rotor coaxially arranged on the journal of the cylinder can be axially moved in the stator.

In DE 196 03 663 A1 a forme cylinder is displaceable in the circumferential direction in respect to the transfer cylinder via a gear and a helical gear. The forme cylinder and the transfer cylinder acting together with it can be driven in parallel by means of a motor. An inking system assigned to the forme cylinder can be driven by means of a spur wheel arranged on the journal of the forme cylinder.

EP 1 000 737 A1 discloses a drive mechanism for a cylinder sleeve via a shaft which can be axially clamped against a disk. An axial coupling, which will allow an axial relative movement, is provided between the drive motor and the sleeve.

Various embodiments of torsionally rigid compensation couplings are disclosed inter alia on pages 407 to 411 of “Taschenbuch für den Maschinenbau” [Mechanical Engineering Handbook], Dubbel, 15th ed.

DE 197 55 316 C2 discloses the drive mechanism for a cylinder by a drive motor via a gear and a “compensating coupling”. Further cylinders are individually driven by means of their own drive motors. Regarding their closeness to the respective cylinder, the drive motors are arranged offset from each other.

An operational connection between a forme cylinder driven via a gear and a transfer cylinder is known from DE 25 53 768 B2, wherein a releasable coupling is arranged between the cylinders for the purpose of selective release.

The object of the invention is based on providing a drive mechanism for a cylinder.

In accordance with the invention, this object is attained by means of the characteristics of claims 1, 2 or 8.

The advantages to be gained by means of the invention rest in particular in that a drive mechanism for axially movable cylinders is created, wherein play in the circumferential direction and a large production outlay is minimized.

A coupling, flexible in the axial direction, is arranged between the drive motor and the forme cylinder to make an axial relative movement between the cylinder, in particular a forme cylinder, and a drive motor driving the forme cylinder possible. In an advantageous embodiment, it is designed as a torsionally rigid shaft coupling, but which is flexible or resilient in the axial direction, for example as an expansion or compensation coupling. The employment of a non-switchable, positively-connected connected multi-disk coupling is particularly advantageous which, in contrast to other positively-connected couplings, is almost free of play in the circumferential direction without an extensive production outlay and simultaneously makes an axial position change of the coupling itself, i.e. an axial movement of the forme cylinder, possible. The coupling is embodied to be positively-connected in the axial direction, but flexible or resilient in its length, for example by means of elastic or reversible deformation.

Driving via the coupling is advantageous, in particular also in case of individual drive mechanism at the individually driven cylinders, but particularly at the forme cylinder for the purpose of adjusting the lateral register. If the cylinders of a printing group are each individually driven by a drive motor, the circumferential register can be changed by means of changes in the relative angular position of the drive motor, and the lateral register by means of the axial displacement, relative to each other. In an advantageous employment, the drive motors are arranged coaxially in respect to the cylinder to be driven.

In the case of cylinders driven in groups, in particular in pairs, the arrangement of the drive motor via the coupling at the forme cylinder of a pair of cylinders being driven together is advantageous. Because of the drive mechanism at the forme cylinder, no movement of the drive motor need to take place when the transfer cylinder is in the print-on and print-off position, such as is sometimes the case when driving takes place directly on the transfer cylinder. A compromise, based on such pivot movements of the transfer cylinder in connection with the position of the drive motor and the engagement of the gear wheels when the drive motor is arranged at the transfer cylinder, can be omitted when driving the forme cylinder. In the other case, the latter can lead to broken teeth or also, because of the play in the drive mechanism, to a reduction of the print quality.

If only the inking system and the transfer cylinder are embodied to be placed against or away from each other, a rigid coupling of the drive motor to a lateral frame can take place. However, in general it is of advantage, also in view of the print quality, to improve properties of running true by arranging a gear, in particular a reduction gear.

In one embodiment the drive motor can be arranged directly axially in respect to the forme cylinder, or the driven cylinder. In order to make possible an axial movement of the forme cylinder for adjusting the lateral register, the coupling which is flexible in the axial direction can be arranged between the journal and the drive motor. The embodiment of the drive motor with a gear arranged between the rotor and the journal of the cylinder, for example a planetary gear, is advantageous in respect to advantageous rpm ranges, in particular in the start-up phase.

An arrangement is advantageous in cases where sturdiness requires a helical gear for the force transfer, wherein the pinion of the drive motor does not act directly on the spur wheel. In this case a displacement of the circumferential register would take place at the same time as an axial movement of the forme cylinder if no additional precautions were taken. Precautions can be, for example, a simultaneous correction via the control device, which requires an outlay of control technology, or instead a permissible relative movement of the journal toward the spur wheel of the forme cylinder which, however, requires guide devices, which cannot be produced, or only with a large outlay, without play in the circumferential direction. A coupling flexible in the axial direction can again be employed for the axial mobility of the forme cylinder.

It is advantageous for the mentioned embodiments of the drive mechanism of the forme cylinder if an inking system assigned to the forme cylinder and, possibly also a dampening system, are driven by the same drive motor. This saves expenses and assures synchronization, provided the gearing conditions are correct.

For the exact rotation of the cylinder and rollers in connection with a common drive mechanism during production, a common flow direction of the moments from the drive motor to the various units to be driven is particularly advantageous. In an advantageous embodiment this is achieved in that driving takes place from the forme cylinder to the transfer cylinder, and from the transfer cylinder to the inking system, i.e. serially. In this connection an embodiment is particularly economical wherein the driving takes place from the transfer cylinder to the inking system via a gear wheel rotatably arranged on the journal of the forme cylinder.

If the inking system and the transfer cylinder are driven in parallel via the forme cylinder, the use of auxiliary runners in case of gear wheel trains, or the use of belt drives, which are as free of play as possible, is required at least for one of the two drive trains.

The steps for embodying a coupling which is torsionally rigid, but axially changeable in length, as well as for a defined direction of moment flow, are used for minimizing the play in the drive mechanism, and thus for improving the printing quality.

Exemplary embodiments of the invention are represented in the drawings and will be described in greater detail in what follows.

Shown are in:

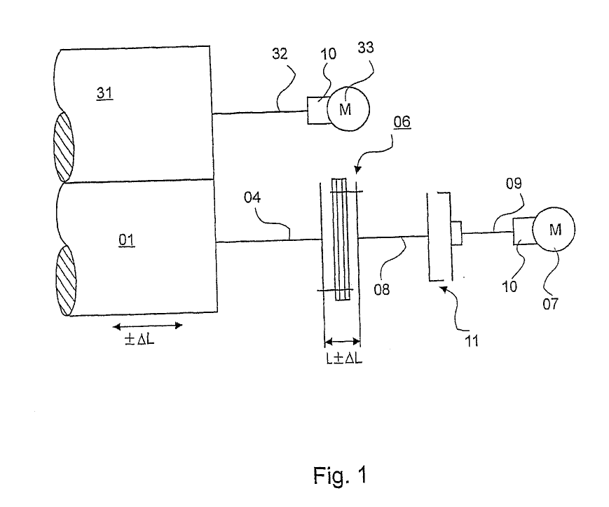

FIG. 1, a first exemplary embodiment of the drive mechanism of a cylinder,

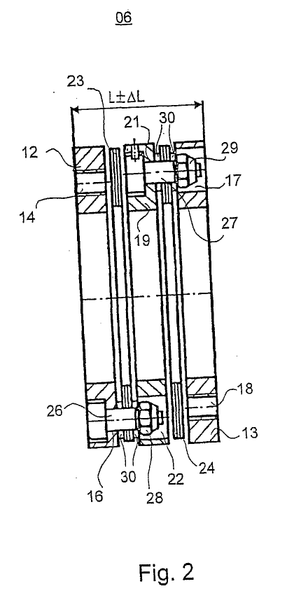

FIG. 2, an example of a coupling which is flexible in the axial direction,

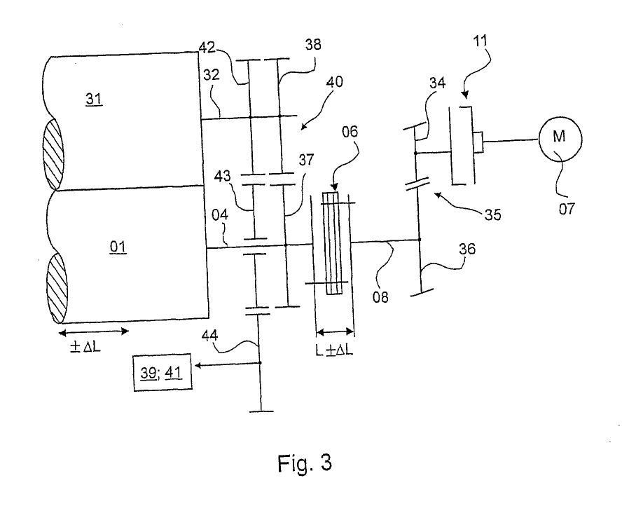

FIG. 3, a second exemplary embodiment of the drive mechanism of a cylinder with a second cylinder and an inking system,

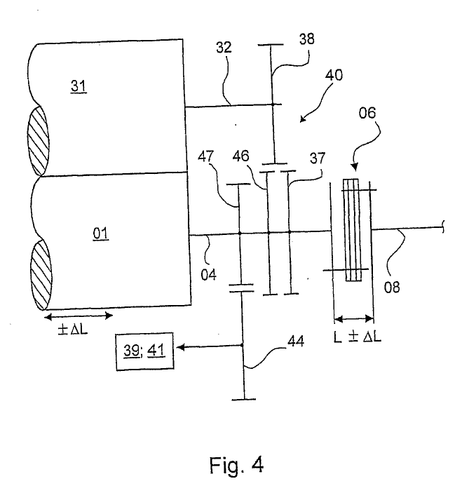

FIG. 4, a third exemplary embodiment of the drive mechanism of a cylinder with a second cylinder and an inking system,

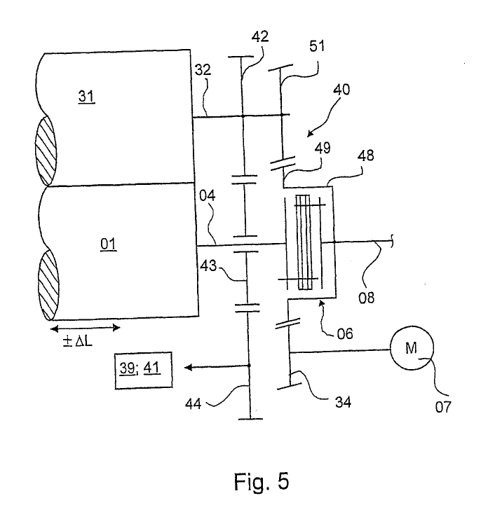

FIG. 5, a fourth exemplary embodiment of the drive mechanism of a cylinder with a second cylinder and an inking system.

A first cylinder 01, for example a forme cylinder 01 of a printing press, in particular a rotary printing press, has on its front face a journal 04, which is rotatably seated in a lateral frame, not represented. On its front end the journal 04 is in operative connection with a drive motor 07 via a coupling 06.

In a first exemplary embodiment (FIG. 1), the coupling 06 is designed as a coupling 06, in particular as a non-switchable, positively-connected shaft coupling 06, or as an expansion coupling 06 which is coaxially connected on its end facing away from the cylinder 01 via a shaft 08 with a shaft 09 of the drive motor 07. In an advantageous embodiment a gear 10, in particular a reduction gear 10, such as a planetary gear 10, for example, is arranged between the drive motor 07 and the coupling 06. This connection between the shaft 08 and the shaft 09 can also be provided by means of a non-switchable coupling 11, for example a claw coupling 11. If deviations in the axial direction of the cylinder 01 and the drive motor 07 must be compensated, the coupling 11 can also be embodied in the manner of a spiral-toothed coupling.

The non-switchable coupling 06 is embodied in such a way that a length L in the axial direction can be changed by an amount Delta L, namely preferably in both directions. In contrast to claw couplings or to couplings having pins or bolts engaging bores, the coupling 06 is embodied in such a way that in the axial direction there is no sliding movement between two parts acting together as stops in the circumferential direction, and instead it is torsionally rigid in the circumferential direction and can be deformed resiliently, or reversibly elastically in the axial direction. The elements constituting the coupling 06 are positively connected with each other in the axial and circumferential directions and therefore, without a large manufacturing outlay, make possible an almost play-free drive in the circumferential direction, and an axial movement of the cylinder 01 by changing the length L. Since there is no relative movement between two surfaces which are used as opposite stops transversely to the movement direction, the coupling 06 is wear-resistant and insensible to soiling.

An example of such a coupling 06, merely symbolically indicated in FIGS. 1, 3, 4 and 5, is represented in FIG. 2. At its respective ends, the coupling 06 has ring-shaped flanges 12, 13 having continuous bores 14, 16, 17, 18, which adjoin in the circumferential direction and extend axially. An also ring-shaped center element 19, or flange 19, with bores 21, 22 is arranged between the two flanges 12, 13, and a multi-disk packet 23, 24, in particular with disks made of steel, and with bores 26, 27 is arranged between the center element 19 and each one of the flanges 12, 13. Now each multi-disk packet 23, 24 is alternatingly fastened in the circumferential direction by means of screws 28, 29 to the adjoining flange 12, 13 and the center element 19 in such a way that it is alternatingly positively connected with the flanges 12, 13 and with the center element 19. Spacer elements 30, for example washers 30, which allow an axial displacement are respectively arranged in the area of the screws 28, 29, between the pretensed multi-disk packet 23, 24 and the flange 12, 13, 19. The preferred disks made of steel assure a high degree of rigidity in the circumferential direction, i.e. in the plane of their surface and perpendicularly in respect to the axis of rotation of the cylinder 01, while the circular disks of lesser thickness have elastic, or spring properties in the axial direction.

Such a coupling 06 is also called a flexurally elastic, all-metal coupling, a diaphragm coupling, or also ring coupling.

Because of this design, because of the rigidity of the disks the coupling 06 is embodied to be torsionally rigid in the circumferential direction and positively connected. The alternating fastening of the multi-disk packets 23, 24 on the flange 12, 13 and the center element 19 allows, in spite of the positive connection in the axial direction, and because of the spring action of the disks in the multi-disk packet 23, 24, a reversible change of the length L of the coupling 06 by an amount Delta L, which is a function of the dimensions of the coupling L. The force to be exerted, i.e. a springiness of the coupling 06 in the axial direction, is a function of the number of disks in the multi-disk packet 23, 24. A torsion spring value of the torque in the coupling 06 is preferably greater than 10,000 Nm/°, in particular in the range between 10,000 and 20,000 Nm/°.

If lesser amounts of Delta L are required, and no axial offset needs to be compensated, the coupling 06 can be embodied with only one multi-disk packet 23, 24 and without a center element 19, or flange 19, in which case the multi-disk packet 23, 24 is fastened in the circumferential direction alternatingly on one and on the other flange 12, 13.

In the exemplary embodiment of FIG. 1, a second cylinder 31, for example a transfer cylinder 31 or a counter-pressure cylinder 31 which works together with the cylinder 01, is driven by means of its own drive motor 33. The operative connection between the drive motor 33 and the journal 32 can also be provided by means of non-switchable couplings 06, 11 (not represented). In an advantageous embodiment a gear 10 is here also arranged between the drive motor 33 and the cylinder 31.

If, for example, the second cylinder 31 is embodied as a transfer cylinder 31, it works together, forming a printing position during printing, with a further, not represented cylinder, for example a further transfer cylinder, a steel cylinder or a satellite cylinder.

If the second cylinder 31 is embodied as a counter-pressure cylinder 31, it forms a printing position together with the forme cylinder 01.

In both cases a lateral displacement of the printed image in relation to the printed image from another printing position might possibly be required during printing, so that the first cylinder 01, embodied as forme cylinder 01, must be axially displaced by the amount Delta L. Preferably this amount Delta L lies between 0 and ±4 mm, in particular between 0 and ±2.5 mm, and is taken up by the change of the length L of the coupling 06 by this amount ±Delta L. The end of the coupling 06 facing away from the forme cylinder 01, for example the flange 13, is arranged fixed in place in regard to an axial direction. Thus, by means of the arrangement of the coupling 06, the associated drive motor 07 can be arranged fixed in place, or fixed on the frame, during the axial displacement of the cylinder 01.

In a second exemplary embodiment (FIG. 3), driving by the drive motor 07 of the shaft 08 connected with the coupling does not take place coaxially, but via a gear 35, in particular a reduction gear 35, for example by means of a pinion 34 to a gear wheel 36 arranged on the shaft 08. Here, too, the arrangement of the coupling 11 between the drive motor 07 and the pinion 34 is advantageous in view of a simple separation. It is additionally possible to place a planetary gear 10 (not represented) before the drive motor 07.

As represented in FIG. 3, it is possible to drive a gear wheel 38, which is arranged, fixed against relative rotation, on the journal 32 of the second cylinder 31, via the coupling 06 from the first cylinder 01 via a gear 40, for example by means of a gear wheel 37, which is arranged, fixed against relative rotation, on the journal 04 of the first cylinder 01. Helical gears on the pinion 34 and the gear wheel 36 are advantageous because of the now occurring greater load. The two cooperating gear wheels 37, 38 on the journals 04, 32 are advantageously provided with straight teeth, because a relative axial movement toward each other is made possible in this way without a compensation in the circumferential register becoming necessary. The gear 40 is located between the coupling 06 and the cylinders 01, 31. In this way the power is transferred as closely as possible to the respective barrel of the respective cylinder 01, 31, which additionally improves the accuracy of the drive mechanism and the printing quality.

In a variation, a not represented inking system 39 and possibly a dampening system 41, are also driven by means of the drive motor 07. In this case driving with a defined moment flow is advantageous.

For this purpose, power is transferred from the first cylinder 01 via the gear wheels 37, 38 to the second cylinder 31, and from the second cylinder 31 via a gear 42, 43, 44 to the inking system 39 and the possible dampening system 41. In FIG. 3 a further gear wheel 42 is arranged, fixed against relative rotation, on the journal 32 of the second cylinder 31 for this purpose and, acting together with it, a further gear wheel 43, which is rotatable relative to the journal 04, is arranged on the journal 04 of the first cylinder 01. The latter gear wheel meshes with a gear wheel 44, which constitutes the drive mechanism for the inking system 39 and the possible dampening system 41. The gear wheels 42, 43, 44, which constitute the drive train for the inking system 39 and the possible dampening system 41, are embodied with straight teeth, so that an axial displacement of the first cylinder 01 does not lead to a relative change in the angular position between the first cylinder 01 and the second cylinder 31, and the first cylinder 01 and the inking system 39 and the possible dampening system 41.

The drive mechanism of the drive connection for the mutual and serial driving of the cylinders 01, 03 and the inking system 39 and the possible dampening system 41 represented in FIG. 3 can also take place in accordance with FIG. 1 by means of a drive motor 07 coaxially arranged in respect to the shaft 08, or the cylinder 01. This applies correspondingly to the arrangement of a gear 10 and possibly a coupling 11.

In a third exemplary embodiment (FIG. 4), power is transferred from the first cylinder 01 parallel to the second cylinder 31 and the inking system 39 and the possible dampening system 41. So that a tooth flank change under changing loads is prevented in spite of the lack of a definite direction of the moment flow, the gear wheel 37 arranged on the journal 04 of the first cylinder 01 is arranged together with a gear wheel 46, for example an auxiliary gear wheel 46. Power can be transferred via a gear wheel 47, also arranged on the journal 04 of the first cylinder 01, to the gear wheel 44 providing the driving of the inking system 39 and of the possible dampening system 41. Driving of the shaft 08 can take place in one of the ways mentioned above either coaxially in respect to the shaft 08, or via a pinion 34, not represented in FIG. 4. This applies correspondingly to the arrangement of the gears 10, or 35, and possibly a coupling 11.

In a fourth exemplary embodiment (FIG. 5), the power transfer from the first cylinder 01 to the second cylinder 03 does not take place on the side of the coupling 06 facing the cylinder 01, but on the side of the coupling 06 which is not movable in the axial direction. For this purpose the driving connection, or the gear 40, between the first cylinder 01 and the second cylinder 31 is not arranged between the coupling 06, whose length L can be changed in the axial direction, and the first cylinder 01, but on the side of the coupling 06 which is facing away from the first cylinder 01 and is stationary.

For the purpose of saving space and of shortening the required length of the journals 04, 32, it is possible to connect a gear wheel 49 which is arranged, for example on a bushing 48 enclosing the coupling 06, with the side of the coupling 06 facing away from the cylinder 01. On the one side, this gear wheel 49 meshes with a gear wheel 51, which is connected, fixed against relative rotation, with the journal 32 of the second cylinder 31, and with the pinion 34. In comparison with FIG. 3, one drive level can be saved with this embodiment, and driving of the cylinders 01, 31 can take place from the drive motor 07 via a helical gear. The drive connection formed by the gear wheels 49 and 51 is not located on the side of the coupling facing the cylinder 01, which is to be moved axially, but on the side which is stationary in respect to an axial movement.

In the exemplary embodiment in accordance with FIG. 5 it is possible to arrange the drive motor 07 coaxially in respect to the shaft 08, while doing without the pinion 35 wherein, however, what was said above applies to a possibly provided gear 10.

As already explained in part, the partially represented planetary gear 10 arranged at the drive motor 07, or between the drive motor 07 and the shaft 08, or between the drive motor 33 and the cylinder 31, is advantageous for all exemplary embodiments, in particular for the embodiment variations having a drive motor 07 which is arranged coaxially in respect to the shaft 08. In this case the gears 10, 35 are preferably designed as single, encapsulated gears, which can contain a thin-bodied lubricant, in particular oil, in their interior. In the case of the drive connection between the two cylinders 01, 31, this gear 40 can also be embodied encapsulated in an advantageous embodiment. However, the coupling 06 is advantageously arranged in none of the encapsulated spaces, but on the outside, and is therefore easily accessible. The latter is the case in particular in connection with the embodiment of the coupling 06 as an above described diaphragm coupling.

The drive connections between the two cylinders 03, 31, and/or between one of the cylinders 03, 31 and the inking system 39, or possibly the dampening system 41, can also be provided by means of toothed belts (taking into consideration the reversal of the circulating direction), or other positively connected drive connections.

The manner of function of the drive mechanism of a cylinder 01, 31 is as follows:

During operation, i.e. during set-up and production operations, the cylinder 01 and, depending on the design, with it the second cylinder 31, and also the inking system 39, or possibly the dampening system 41, are driven by means of the drive motor 07.

If a correction of the lateral system, i.e. a lateral displacement of the printed image, is required, the cylinder 01 is displaced in the axial direction by an amount Delta L by means of a not represented drive mechanism arranged preferably on the side of the cylinder 01 located opposite the drive mechanism, without the drive motor 07 also having to be displaced. The amount Delta L of the displacement is taken up by the coupling 06, wherein the end of the latter remote from the cylinder 01 is fixed in place, in particular fixed in place in respect to the axial direction. The displacement does not cause a simultaneous displacement of the circumferential register.

A control by means of an electronic shaft between the cylinders 01, 31, as well as a mechanical readjustment of the circumferential register, can be omitted.

List of Reference Symbols

01 Cylinder, first, forme cylinder

02 -

03 -

04 Journal (01)

05 -

06 Coupling, elastic, coupling, shaft coupling, resilient, expansion coupling

07 Drive motor

08 Shaft

09 Shaft (07)

10 Gear, reduction gear, planetary gear

11 Coupling, claw coupling

12 Flange (06)

13 Flange (06)

14 Bore (12)

15 -

16 Bore (12)

17 Bore (13)

18 Bore (13)

19 Center element, flange (06)

20 -

21 Bore

22 Bore (19)

23 Multi-disk packet (06)

24 Multi-disk packet (06)

25 -

26 Bore (23)

27 Bore (24)

28 Screw (06)

29 Screw (06)

30 Washers

31 Cylinder, second, transfer cylinder, counter-pressure cylinder

32 Journal (31)

33 Drive motor (31)

34 Pinion

35 Gear, reduction gear (34, 36)

36 Gear wheel (08)

37 Gear wheel (04)

38 Gear wheel (32)

39 Inking system

40 Gear (37, 38)

41 Dampening system

42 Gear wheel (32)

43 Gear wheel (04)

44 Gear wheel (39)

45 -

46 Gear wheel, auxiliary gear wheel (37)

47 Gear wheel (04)

48 Bushing

49 Gear wheel (48)

50 -

51 Gear wheel (32)

L Length (18)

Delta L Amount of longitudinal change (06), of the axial displacement (01)

1. A drive mechanism for a cylinder (01, 31) of a printing press by means of a drive motor (07), wherein a coupling (06) is arranged between the drive motor (07) driving the cylinder (01, 31) and the cylinder (01, 31), which allows a relative movement in the axial direction between the cylinder (01, 31) and the drive motor (07) driving the cylinder (01, 31), characterized in that the coupling (06) has at least one multi-disk packet (23, 24), which is positively connected with flanges (12, 13, 19), and whose length (L) can be changed in the axial direction of the cylinder (01, 31) by an amount (±Delta L).

2. A drive mechanism for a cylinder (01, 31) of a printing press by means of a drive motor (07), wherein a coupling (06) is arranged between the drive motor (07) driving the cylinder (01, 31) and the cylinder (01, 31), which allows a relative movement in the axial direction between the cylinder (01, 31) and the drive motor (07) driving the cylinder (01, 31), characterized in that the coupling (06) is arranged outside the lubricant chamber.

3. The drive mechanism in accordance with claim 2, characterized in that the coupling (06) has at least one multi-disk packet (23, 24), which is positively connected with flanges (12, 13, 19), and whose length (L) can be changed in the axial direction of the cylinder (01, 31) by an amount (±Delta L).

4. The drive mechanism in accordance with claim 1 or 2, characterized in that a gear (10, 35) is arranged between the drive motor (07) and the coupling (06).

5. The drive mechanism in accordance with claim 1 or 2, characterized in that a second cylinder (31) assigned to the cylinder (01) can be driven from the first cylinder (01) by means of the same drive motor (07) via a gear (40) acting between the cylinders (01, 31).

6. The drive mechanism in accordance with claim 1 or 2, characterized in that a cylinder (31) assigned to the cylinder (01) can be driven by its own drive motor (33).

7. The drive mechanism in accordance with claim 1 or 2, characterized in that a gear (10, 35) is arranged between the second cylinder (31) and the drive motor (33).

8. A drive mechanism for a first cylinder (01, 31) of a printing press by means of a drive motor (07), wherein a coupling (06) is arranged between the drive motor (01) and the cylinder (01, 31), and at least a first gear (10, 35) is arranged between the drive motor (07) and the coupling (06), characterized in that the coupling (06) is embodied as a coupling (06) whose length (L) can be changed by an amount (±Delta L) in the axial direction of the cylinder (01, 31) and which permits a relative movement in the axial direction between the cylinder (01, 31) and the drive motor (07) driving the cylinder (01, 03), and that a second cylinder (31, 01) can be driven from the first cylinder (01, 31) by means of the same drive motor (07) via a second gear (40), which is arranged between the coupling (06) and the first cylinder (01, 31).

9. The drive mechanism in accordance with claim 1, 2 or 8, characterized in that the drive motor (07) is arranged fixed in place on the frame.

10. The drive mechanism in accordance with claim 4, 7 or 8, characterized in that the gear (10, 35) between the drive motor (07) and the coupling (06) is embodied as an individually encapsulated gear (10, 35) with a closed lubricant chamber.

11. The drive mechanism in accordance with claim 10, characterized in that the coupling (06) is arranged outside of a lubricant chamber.

12. The drive mechanism in accordance with claim 1, 2 or 8, characterized in that the coupling (06) is embodied as a coupling (06) which is positively connected in the axial direction.

13. The drive mechanism in accordance with claim 1, 2 or 8, characterized in that the coupling (06) is embodied as a coupling (06) which is resilient in the axial direction.

14. The drive mechanism in accordance with claim 1, 2 or 8, characterized in that the coupling is embodied as a shaft coupling (06), which is positively connected in the circumferential direction, is torsionally rigid and non-switchable.

15. The drive mechanism in accordance with claim 2 or 8, characterized in that the coupling (06) has at least one multi-disk packet (23, 24), which is positively connected with flanges (12, 13, 19).

16. The drive mechanism in accordance with claim 1 or 15, characterized in that the multi-disk packet (23, 24) is alternately connected in the circumferential direction with the flange (12, 19) facing the cylinder (01, 31), and the flange (19, 13) facing the drive motor (07).

17. The drive mechanism in accordance with claim 1, 6 or 8, characterized in that a shaft (09) of the drive motor (07, 33) driving the cylinder (01, 31) is arranged coaxially and parallel in respect to an axis of rotation of the cylinder (01, 31).

18. The drive mechanism in accordance with claim 17, characterized in that the shaft (09) of the drive motor (07, 33) driving the cylinder (01, 31), or an extending shaft (08) is in operative connection with the side of the coupling (06) facing away from the cylinder (01, 31).

19. The drive mechanism in accordance with claim 1, 2 or 8, characterized in that, on the side of the coupling (06) facing away from the cylinder (01, 31), a shaft (08) is arranged, fixed against relative rotation, coaxially and parallel in respect to an axis of rotation of the cylinder (01, 31).

20. The drive mechanism in accordance with claim 4, 7 or 8, characterized in that the gear (10, 35) has a gear wheel (36), which is arranged, fixed against relative rotation, on the shaft (08), and a pinion (34) meshing with the gear wheel.

21. The drive mechanism in accordance with claim 4, 7 or 8, characterized in that a planetary gear (10) is arranged between the drive motor (07, 33) and the cylinder (01, 31).

22. The drive mechanism in accordance with claim 1, 2 or 8, characterized in that the cylinder (01) is embodied as a forme cylinder (01).

23. The drive mechanism in accordance with claim 1, 2 or 8, characterized in that an inking system (39), and possibly a dampening system (41), assigned to the cylinder (01) can be driven by means of the same drive motor (07).

24. The drive mechanism in accordance with claims 5 or 8, characterized in that the inking system (39), and possibly the dampening system (41), can be driven via a gear (42, 43, 44) from the second cylinder (31).

25. The drive mechanism in accordance with claim 5 or 8, characterized in that the gear (40) between the first cylinder (01) and the second cylinder (31) is embodied as a wheel train (37, 38, 49, 44), which has a gear wheel (37, 49), which is at least connected in a torsionally rigid manner with the journal (04) of the first cylinder (01), and a gear wheel (38, 51) acting together with it, which is connected, fixed against relative rotation, with a journal (32) of the second cylinder (31).

26. The drive mechanism in accordance with claim 24, characterized in that gear (42, 43, 44) between the second cylinder (31) and the inking system (39) and possibly the dampening system (41) is embodied as a wheel train (42, 43, 44), which has a gear wheel (42) arranged fixed against relative rotation on a journal (32) of the second cylinder, a gear wheel (43), acting together with it and rotatably seated on the journal (04) of the forme cylinder (01), and a gear wheel (44), acting together with the latter, of the inking system (39) and possibly the dampening system (41).

27. The drive mechanism in accordance with claim 1, 2 or 8, characterized in that an inking system (39) assigned to the first cylinder (01) and the second cylinder (31) can be driven in parallel via a respective gear (40, 47, 44) from the first cylinder (01).

28. The drive mechanism in accordance with claim 1, 2 or 8, characterized in that the cylinder (01) is axially displaceable for the purpose of adjusting and/or regulating the lateral register.

29. The drive mechanism in accordance with claim 5 or 8, characterized in that the second cylinder (31) is embodied as a transfer cylinder (31).

30. The drive mechanism in accordance with claim 5 or 8, characterized in that the second cylinder (31) is embodied as a counter-pressure cylinder (31) which, together with the forme cylinder (01), constitutes a printing position.
